(19) United States
(12) Patent Application Publication
(10) Pub. No.: US 2006/0138925 A1
(43) Pub. Date: Jun. 29, 2006

(54) PLASMA PROCESSING DEVICE HAVING A RING-SHAPED AIR CHAMBER FOR HEAT DISSIPATION

(76) Inventors: Yi-Fang Cheng, Hsin-Chu Hsien (TW); Hsiao-Pang Chou, Taipei Hsien (TW)

Correspondence Address: NORTH AMERICA INTELLECTUAL PROPERTY CORPORATION, P.O. BOX 506, MERRIFIELD, VA, 22116, US

(21) Appl. No.: 10/905,333

(22) Filed: Dec. 28, 2004

(51) Int. Cl. H01J 7/24; H01J 17/26

(52) U.S. Cl. 313/231.31; 315/111.21

(57) ABSTRACT

A plasma processing device has a housing, a metal plate, an inner ring, and an outer ring. A vacuum chamber is formed in the housing. An air vent is installed on an upper end of the vacuum chamber for venting gaseous reactants into the vacuum chamber when performing a plasma process. The metal plate has a channel for venting gaseous matter and at least a vertical vent hole for guiding the gaseous reactants into the vacuum chamber. The inner ring and the outer ring are positioned between the housing and the metal plate, and the inner ring is surrounded by the outer ring. An air chamber formed between the inner ring and the outer ring connects with the channel of the metal plate.

### BACKGROUND OF INVENTION

b 1. Field of the Invention

The present invention relates to a plasma processing device, and more particularly, to a plasma processing device having a ring-shaped air chamber for heat dissipation.

2. Description of the Prior Art

Plasma etching processes are widely performed in semiconductor manufacturing processes for removing materials on exposed surfaces of a semiconductor wafer by photo-resist so as to transfer a pattern of a mask onto a surface of the semiconductor wafer. The plasma etching processes are performed by utilizing plasma to deionize reactive gaseous molecules into ions. These ions will react with thin film materials on the exposed surfaces of the wafer so that the thin film materials will become volatilized materials. The volatilized materials will then be removed from the surface of the semiconductor wafer in a vacuum system.

A plasma etching process is performed in a plasma processing device. A prior art plasma processing device comprises a housing having a vacuum chamber in it, a metal plate fastened to an upper end of the vacuum chamber and used as an electrode for performing a plasma process, and a bottom chuck installed on a bottom end of the vacuum chamber for loading a semiconductor wafer. The metal plate is connected with a radio frequency power source and forms a radio frequency reactor with the grounded chassis so as to generate plasma.

Please refer to FIG. 1, which is a perspective view of a prior art plasma processing device 10. The plasma processing device 10 comprises a radio frequency (RF) power source 12, a housing 16, a first metal plate 18, and a second metal plate 20. The housing 16 has a vacuum chamber 14 in it. The first metal plate 18 and the second metal plate 20 are fastened to the upper end of the vacuum chamber 14 via screws. The housing 16 has an air vent 17 installed on the upper end of the vacuum chamber 14 for carrying gaseous reactants into the vacuum chamber 14 when performing a plasma process.

Please refer to FIGS. 1-3. FIG. 2 is a top view of the first metal plate 18, and FIG. 3 is a top view of the second metal plate 20. The first metal plate 18 has a first vertical vent hole 19, and the second metal plate 20 has a plurality of second vertical vent holes 21. The gaseous reactants imported from the air vent 17 flows through the vent holes 19 and 21 into the vacuum chamber 14. When performing the plasma process, the RF power source 12 introduces a RF power into the vacuum chamber 14 to form a plasma environment to ionize the gaseous reactants. Therefore, the temperature in the vacuum chamber 14 is risen. To dissipate heat from the housing 16, a cooling apparatus is installed on the outside of the housing 16. However, the air pressure in the vacuum chamber 14 is very low when the plasma process is performed, so the heat transmission of air in the vacuum chamber 14 is feeble. Even the two metal plates 18, 20 and the housing 16 are fastened with screws, because the contacting areas of the screws with the metal plates 18, 20 and the housing 16 are tiny, the heat transmission among the metal plates 18, 20 and the housing 16 is weak.

Therefore, the metal plates 18, 20 cannot be cooled down properly when performing the plasma process, so the lifetimes of the metal plates 18, 20 are shortened.

### Summary of Invention

It is therefore a primary objective of the present invention to provide a plasma processing device which has a ring-shaped air chamber for heat dissipation to solve the above mentioned problems.

The plasma processing device has a housing, a plurality of metal plates, a plurality of inner rings, and a plurality of outer rings. A vacuum chamber is formed in the housing. An air vent is installed on an upper end of the vacuum chamber for venting gaseous reactants into the vacuum chamber when performing a plasma process. Each of the metal plates has a channel for venting gaseous matter and at least a vertical vent hole for guiding the gaseous reactants into the vacuum chamber. The inner rings and the outer rings are positioned among the housing and the metal plates, and each of the inner rings is surrounded by a corresponding one of the outer rings. A plurality of air chambers are formed among the inner rings and the outer rings and connect with the channels of the metal plates.

When performing the plasma process, the air pressure in the air chambers is greater than air pressure in the vacuum chamber, so heat of the metal plates can be dissipated easier to the housing via the air chambers.

These and other objectives of the present invention will no doubt become obvious to those of ordinary skill in the art after reading the following detailed description of the preferred embodiment that is illustrated in the various figures and drawings.

### BRIEF DESCRIPTIONS OF DRAWINGS

FIG. 1 is a perspective view of a prior art plasma processing device.

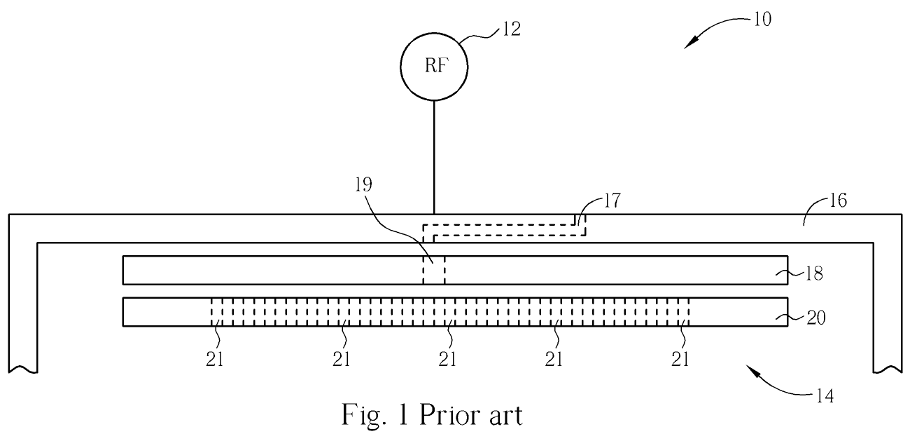

FIG. 2 is a top view of a first metal plate of the plasma processing device shown in FIG. 1.

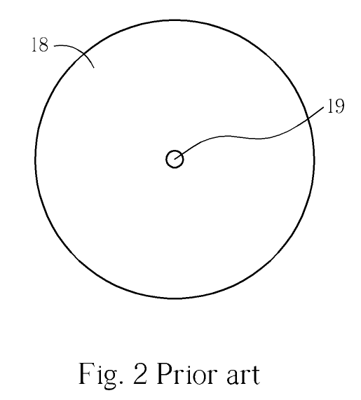

FIG. 3 is a top view of the second metal plate of the plasma processing device shown in FIG. 1.

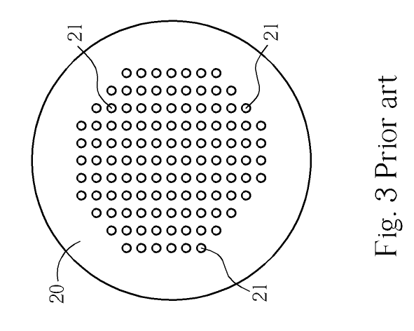

FIG. 4 is a perspective view of a plasma processing device according to the present invention.

FIG. 5 is a top view of a first metal plate of the plasma processing device shown in FIG. 4.

FIG. 6 is a top view of the second metal plate of the plasma processing device shown in FIG. 4.

FIG. 7 is an enlarged view of the plasma processing device shown in FIG. 4.

### DETAILED DESCRIPTION

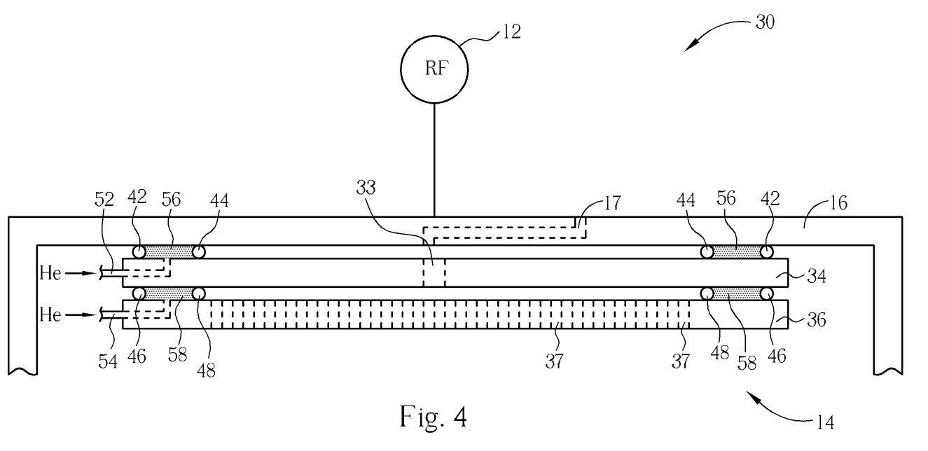

Please refer to FIG. 4, which is a perspective view of a plasma processing device 30 according to the present invention. Similar to the prior art plasma processing device 10, the plasma processing device 30 also has a RF power source 12, a housing 16, a first metal plate 34, and a second metal plate 36. The housing 16 has a vacuum chamber 14 in it. The first metal plate 34 and the second metal plate 36 are fastened to the upper end of the vacuum chamber 14 via screws. The housing 16 has an air vent 17 installed on the upper end of the vacuum chamber 14 for carrying gaseous reactants into the vacuum chamber 14 when performing a plasma process. Different from the plasma processing device 10, the plasma processing device 30 has a plurality of outer rings 42, 46 and a plurality of inner rings 44, 48 positioned among the housing 16 and the two metal plate 34, 36, and each of the metal plates 34, 36 has a channel 52 or 54 in it for importing gaseous matter.

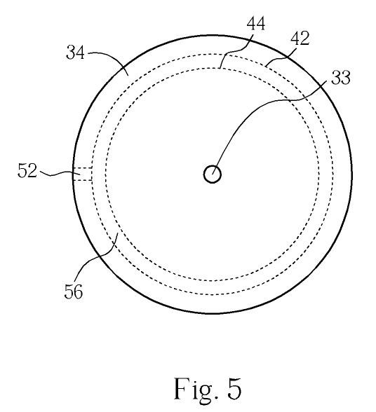

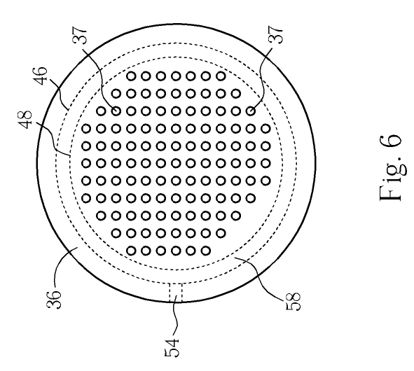

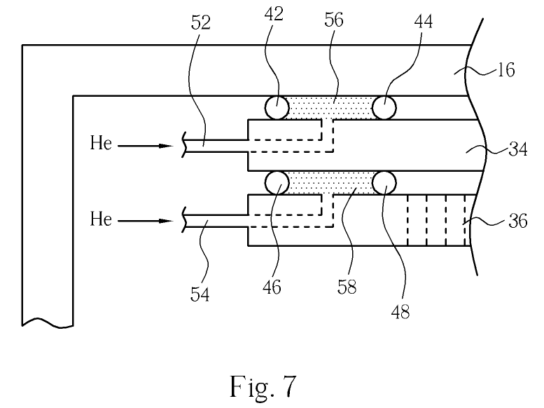

Please refer to FIGS. 4-7, where FIG. 5 is a top view of a first metal plate of the plasma processing device shown in FIG. 4, FIG. 6 is a top view of the second metal plate of the plasma processing device shown in FIG. 4, and FIG. 7 is an enlarged view of the plasma processing device shown in FIG. 4. The first metal plate 34 comprises a first vertical vent hole 33, and the second metal plate 36 comprises a plurality second vertical vent hole 37. The vent holes 33, 37 are used to guide the gaseous reactants from the air vent 17 into the vacuum chamber 14. When performing the plasma process, the RF power source 12 introduces a RF power into the vacuum chamber 14 to form a plasma environment to ionize the gaseous reactants from the air vent 17. Therefore, the temperature in the vacuum chamber 14 is risen. To dissipate heat from the housing 16, a cooling apparatus (not shown) is installed on the outside of the housing 16.

As shown in FIGS. 4-5, a ring-shaped air chamber 56 is formed between the outer ring 42 and the inner ring 46, and the channel 52 of the first metal plate 34 connects with the air chamber 56. As shown in FIGS. 4 and 6, another ring-shaped air chamber 58 is formed between the outer ring 46 and the inner ring 48, and the channel 54 of the second metal plate 36 connects with the air chamber 56. When performing the plasma process, the air pressure in the vacuum chamber 14 is less than 5 torr, and helium is imported into the air chambers 56 and 58 via the channels 52 and 54. Therefore, the air pressure in the air chambers 56 and 58 is greater than the air pressure in the vacuum chamber 14 when the plasma process is performed. Because the air chambers 56 and 58 are full of helium, heat can be transmitted among the metal plates 34, 36 and the housing 16 via the helium in the air chambers 56, 58. Moreover, helium is a kind of inert gas, so it cannot react to any material in the vacuum chamber 14.

It is noted that the present invention is not limited by the above embodiment. For example, the number of metal plates of the plasma processing device can be different from 2, i.e. 1 or a number greater than 2. Moreover, the gaseous matter imported to the air chambers can be not only helium but also other inert gas, i.e. neon or argon.

Compared with the prior art, the plasma processing device according to the present invention has ring-shaped air chamber for heat dissipation. When performing a plasma process, the air pressure in the air chambers is greater than air pressure in the vacuum chamber, so heat of the metal plates can be dissipated easier to the housing via the air chambers.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A plasma processing device used in a semiconductor manufacturing process comprising:
a housing having a vacuum chamber in it, the housing comprising an air vent installed on an upper end of the vacuum chamber for carrying gaseous reactants into the vacuum chamber when performing a plasma process;
a first metal plate comprising a first channel for importing gaseous matter and at least a first vertical vent hole for guiding the gaseous reactants from the air vent into the vacuum chamber;
an inner ring positioned between the housing and the first metal plate and contacting tightly with the housing and the first metal plate; and
an outer ring positioned between the housing and the first metal plate and contacting tightly with the housing and the first metal plate, the outer ring surrounding the inner ring, and an first air chamber formed between the inner ring and the outer ring being connected with the first channel.

2. The plasma processing device of claim 1 further comprising: at least a second metal plate comprising a second channel for importing gaseous matter and a plurality of second vertical vent holes for guiding the gaseous reactants from the air vent and the first channel into the vacuum chamber;
a second inner ring positioned between the first metal plate and the second metal plate and contacting tightly with the first metal plate and the second metal plate; and
a second outer ring positioned between the first metal plate and the second metal plate and contacting tightly with the first metal plate and the second metal plate, the second outer ring surrounding the second inner ring, and an second air chamber formed between the second inner ring and the second outer ring being connected with the second channel.

3. The plasma processing device of claim 1 further comprising a radio frequency (RF) power source for introducing a RF power into the vacuum chamber to form a plasma environment to ionize the gaseous reactants.

4. The plasma processing device of claim 1 wherein the gaseous matter imported from the first channel is inert gas.

5. The plasma processing device of claim 1 wherein air pressure in the first air chamber is greater than air pressure in the vacuum chamber when performing the plasma process.

6. The plasma processing device of claim 1 wherein air pressure in the vacuum chamber is less than 5 torr when performing the plasma process.

7. The plasma processing device of claim 1 further comprising a cooling apparatus positioned outside the vacuum chamber for cooling the housing.

8. A plasma processing device used in a semiconductor manufacturing process comprising:
a housing having a vacuum chamber in it, the housing comprising an air vent installed on an upper end of the vacuum chamber for carrying gaseous reactants into the vacuum chamber when performing a plasma process;
a plurality of metal plates stacked vertically, each of the metal plates comprising a channel for importing gas and at least a vertical vent hole for guiding the gaseous reactants from the air vent into the vacuum chamber;
a plurality of inner rings positioned among the housing and the metal plates; and
a plurality of outer rings positioned among the housing and the metal plates, each of the outer rings surrounding a corresponding one of the inner rings, a plurality of air chambers formed among the inner rings and the outer rings, and each of the air chambers being connected with a corresponding one of the channels.

9. The plasma processing device of claim 8 further comprising a radio frequency (RF) power source for introducing a RF power into the vacuum chamber to form a plasma environment to ionize the gaseous reactants.

10. The plasma processing device of claim 8 wherein the gaseous matter imported from the channels is inert gas.

11. The plasma processing device of claim 8 wherein air pressure in the air chambers is greater than air pressure in the vacuum chamber when performing the plasma process.

12. The plasma processing device of claim 8 wherein air pressure in the vacuum chamber is less than 5 torr when performing the plasma process.

13. The plasma processing device of claim 8 further comprising a cooling apparatus positioned outside the vacuum chamber for cooling the housing.
